(19) United States
(12) Patent Application Publication
(10) Pub. No.: US 2026/0135031 A1
(43) Pub. Date: May 14, 2026

(54) ELECTRICAL MACHINE

(71) Applicant: MAHLE International GmbH, Stuttgart (DE)

(72) Inventors: Moritz Aron, Karlsruhe (DE); Marius Ebli, Eichstaett (DE); Thorsten Grelle, Stuttgart (DE); Johannes Hildebrandt, Dresden (DE); Juergen Tschullik, Berching (DE)

(21) Appl. No.: 18/705,519

(22) PCT Filed: Aug. 25, 2022
(86) PCT No.: PCT/EP2022/073723

§ 371 Date: Apr. 26, 2024

(30) Foreign Application Priority Data
Oct. 27, 2021 (DE) 10 2021 212 153.5

(51) Int. Cl. H01F 38/18; H02K 1/12; H02K 1/22; H02K 7/00

(52) U.S. Cl. CPC H01F 38/18; H02K 1/12; H02K 1/22; H02K 7/003

(57) ABSTRACT

An electrical rotary transformer for inductive energy transmission may include a rotary transformer stator, a rotary transformer rotor rotatable relative to the rotary transformer stator, and a capacitive coupler for capacitive electrical signal transmission between the rotary transformer stator and the rotary transformer rotor. The rotary transformer stator may include a primary coil. The rotary transformer rotor may include a secondary coil inductively couplable to the primary coil. The capacitive coupler may be partly formed on the rotary transformer stator and the rotary transformer rotor. The capacitive coupler may include two plate capacitors that may each include a first and a second plate element. The two first plate elements may be arranged on the stator. The two second plate elements may be arranged on the rotary transformer rotor. The first plate element and the second plate element of each plate capacitor may be disposed opposite one another for capacitive coupling.

### CROSS-REFERENCE TO RELATED APPLICATIONS

This application claims priority to International Patent Application No. PCT/EP 2022/073723 filed Aug. 25, 2022, which also claims priority to German Patent Application DE 10 2021 212 153.5 filed Oct. 27, 2021, each of which is hereby incorporated by reference in its entirety.

### TECHNICAL FIELD

The present invention relates to an electric machine which can be a drive motor or traction motor for driving a vehicle. Preferably it is a synchronous machine which can be permanently excited or externally excited.

### BACKGROUND

Usually, an electric machine comprises a stator and a rotor which is rotatable about an axis of rotation relative to the stator. During the operation of such an electric machine heat is generated. In the case of powerful electric machines such as for example traction motors, a lot of heat develops in the process which has to be dissipated in order to avoid overheating electrical and/or electronic components of the electric machine. Apart from this, the service life of the components can be substantially extended by cooling the same. There is therefore a need for creating a way for an efficient cooling for such electric machines.

The present invention deals with the problem of stating for an electric machine of the type described above a way for an improved or at least different cooling.

According to the invention, this problem is solved through the subject of the independent claims. Advantageous embodiments are subject of the dependent claims.

### SUMMARY

The invention is based on the general idea of configuring a rotor shaft of the rotor in an electric machine comprising a stator and a rotor, hollow, so that the rotor shaft includes a coolant distribution channel which can be supplied with a coolant via an axial coolant inlet during the operation of the electric machine. The coolant can be gaseous or liquid. In addition, the rotor shaft carries a magnetic-field generating arrangement which generates a magnetic rotor field at least during the operation of the electric machine. This magnetic-field generating arrangement has a first axial arrangement end and a second axial arrangement end. The rotor shaft now comprises multiple first radial outlet openings on the first axial arrangement end, which are open to the coolant distribution channel, i.e. lead into the same. Apart from this, the rotor shaft comprises multiple second radial outlet openings on the second axial arrangement end which are open to the coolant distribution channel, i.e. lead into the same. During the operation of the electric machine, coolant can now exit from the coolant distribution channel through the outlet openings and flow along the respective arrangement end. Thus, an efficient cooling of the magnetic-field generating arrangement is realised at the respective arrangement end. Apart from this, winding heads of a stator winding, which can likewise be impinged upon by the coolant, are usually situated at the arrangement ends.

The axis of rotation defines a longitudinal direction or axial direction of the electric machine which extends parallel to the axis of rotation. A radial direction extends perpendicularly to the axis of rotation and a circumferential direction extends round about the axis of rotation.

According to an advantageous embodiment, the rotor can comprise at the first arrangement end a first compensation ring that is non-rotatably arranged on the rotor shaft. The first compensation ring comprises for each first radial outlet opening an inflow chamber, which is open to the respective first radial outlet opening, i.e. the respective first outlet opening leads into the respective first inflow chambers. In addition, the rotor comprises on the second arrangement end a second compensation ring that is non-rotatably arranged on the rotor shaft, which for each second radial outlet opening comprises a second inflow chamber, which is open to the respective second radial outlet opening, i.e. the respective second outlet opening leads into the respective second inflow chambers. Thus, the coolant enters the inflow chambers through the outlet openings during the operation of the electric machine. Practically, the magnetic-field generating arrangement can now comprise multiple first cooling channels and multiple second cooling channels which extend axially and alternate in the circumferential direction. On the inlet side, the first cooling channels lead into a first inflow chamber each. On the inlet side, the second cooling channels lead into a second inflow chamber each. The first compensating ring now additionally comprises in the circumferential direction between each two first inflow chambers a first outflow chamber each, into which a second cooling channel each leads on the outlet side and which is open radially to the outside, so that the coolant can exit from the respective first outflow chamber there. The second compensation ring comprises in the circumferential direction between each two second inflow chambers a second outflow chamber each, into which a first cooling channel each leads on the outlet side and which is open radially to the outside so that the coolant can exit from the respective second outflow chamber there. During the operation of the electric machine, the coolant accordingly flows from the coolant distribution channel through the radial outlet openings into the inflow chambers and from the inflow chambers into the cooling channels and from the cooling channels into the outflow chamber, from where the coolant then flows away from the rotor. Thus, an efficient cooling of the magnetic-field generating arrangement is realised. Apart from this, electronic components of the electric machine can be arranged on the first compensation ring and/or on the second compensation ring. For example, with an externally excited synchronous machine a control for generating the rotor field can be arranged on the rotor. These components arranged on the respective compensation ring can thus be efficiently cooled.

It is noteworthy, further, that the magnetic-field generating arrangement in the first cooling channels is flowed through in a first axial direction while in the second cooling channels it is flowed through in an opposite second axial direction. A particular advantage with this arrangement is that during the operation of the electric machine, through the rotation of the rotor, centrifugal forces act on the coolant in the first and second inflow chambers, as a result of which the coolant is driven in the desired flow direction. The consequence of this is that the electric machine according to the invention, for the cooling of the rotor introduced here, does not require any or only a comparatively low-capacity or small-dimensioned delivery device for driving the coolant, which reduces the manufacturing costs and the installation space requirement accordingly.

According to an advantageous further development, the inflow chambers and the outflow chamber can each extend and overlap in the circumferential direction in the respective compensation ring so that the respective inflow chamber adjoins the respective outflow chamber radially outside. Thus, the inflow chambers can be dimensioned comparatively large so that at the respective arrangement end they occupy a comparatively large area portion. This improves the cooling for the respective arrangement end. Apart from this, it can thereby be achieved with suitable matching to the direction of rotation of the rotor during the operation of the electric machine that in the region of the inlet port of the respective cooling channel a comparatively high dynamic pressure can be achieved which drives the coolant into the respective cooling channel.

Another further development proposes that the inflow chambers in the respective compensation ring are each separated by a first and second separating wall from the respective outflow chamber so that the respective first and second separating wall delimits the respective inflow chamber radially inside and delimits the respective outflow chamber radially outside. The respective separating wall thus forms a common limitation for the adjacent inflow chamber and outflow chamber, which simplifies the construction of the respective compensation ring.

According to another further development, the respective outflow chamber can in the respective compensation ring an outflow opening each, wherein the respective first and second outflow opening is oriented so that during the operation of the electric machine it is open radially and in the circumferential direction counter to a direction of rotation of the rotor, so that preferentially the coolant can exit from the respective outflow chamber substantially tangentially. By way of this orientation and positioning of the respective outflow opening, the coolant, during the operation of the electric machine can still be driven by centrifugal forces through the rotation of the coolant even in this region With another further development, the first cooling channels and the second cooling channels can be arranged within the magnetic-field generating arrangement radially outside. Thus, a comparatively large radial distance between the cooling channels and the coolant distribution channel is realised, which correspondingly increases the effective centrifugal forces and improves the drive for the coolant.

Practically it can now be provided that within the respective compensation ring the cooling channels on the outlet side lead to the region of the outflow opening of the respective outflow chamber in each case. In addition or alternatively it can be provided that within the respective compensation ring the respective outflow chamber in the circumferential direction converges towards the respective outflow opening, i.e. has a decreasing cross-section that can be flowed through. These measures favour the flow of the coolant which improves the efficiency of the cooling.

In another advantageous embodiment it can be provided that in the respective compensation ring the respective inflow chamber diverges from the associated radial outlet opening in the direction of the respective cooling channel, i.e. has an increasing cross-section that can be flowed through. On the one hand, this favours the flow through the respective inflow chambers and on the other hand makes possible an increased pressure in particular through dynamic pressure on the inlet-side port to the respective cooling channel.

Particularly advantageous now is an embodiment, in which the electric machine is configured as externally excited electric machine, so that the magnetic-field generating arrangement comprises at least one rotor coil for generating the magnetic rotor field. Windings of the rotor coil are applied to multiple pole shoes distributed in the circumferential direction, which are non-rotatably arranged on the rotor shaft. The first cooling channels and the second cooling channels can now extend in the circumferential direction between adjacent pole shoes within the magnetic-field generating arrangement. Usually, longitudinal grooves are formed in the magnetic-field generating arrangement in circumferential direction between the pole shoes in order to be able to realise the windings. The cooling channels can extend in these longitudinal grooves or be formed by these.

In another embodiment, in which the electric machine is likewise externally excited and comprises at least one rotor coil, windings of the rotor coil can comprise winding ends at the arrangement ends. By conducting the coolant via the outlet openings along the arrangement ends, these winding ends are intensively cooled. When the compensation rings are additionally provided, it can be practically provided that the inflow chambers and/or the outflow chambers of the first and/or of the second compensation ring are open towards the winding ends. The respective chamber can be open along its entire extent. It is likewise conceivable that a wall of the respective compensation ring facing the respective arrangement end contains at least one opening or in the manner of a perforation contains many openings in the region of the respective chamber. Thus, a direct impingement of the winding ends by the coolant can also be realised here.

The externally excited electric machine can be externally excited in a conductive or inductive manner.

In an alternative embodiment, the electric machine can be configured as permanently excited electric machine, so that the magnetic-field generating arrangement then comprises multiple permanent magnets for generating the magnetic rotor field. In this case, the magnetic-field generating arrangement in its body carrying the permanent magnets can comprise multiple axially extending flux separating gaps, so-called “flux barriers”. These flux separating gaps are each arranged in the circumferential direction between two adjacent permanent magnets in order to reduce the magnetic flux through the body of the magnetic-field generating arrangement between the two permanent magnets. Practically it can now be provided that the first and second cooling channels are formed by these flux separating gaps or are formed therein.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention. Parts mentioned above and still to be mentioned in the following of a superior unit such as for example an installation, a device or an arrangement that are designated separately, can form separate parts or components of this unit or be integral regions or sections of this unit, even if this is shown differently in the drawings.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1: a highly simplified schematic longitudinal section through an electric machine,

FIG. 2: a highly simplified schematic cross-section through the electric machine in the region of a first compensation ring according to section lines II in FIG. 1,

FIG. 3: a highly simplified schematic cross-section through the electric machine in the region of a second compensation ring according to section lines III in FIG. 1,

FIG. 4: a highly simplified schematic cross-section through a sector of a rotor with an externally excited electric machine,

FIG. 5: a highly simplified schematic cross-section through a sector of a rotor with a permanently excited electric machine.

### DETAILED DESCRIPTION

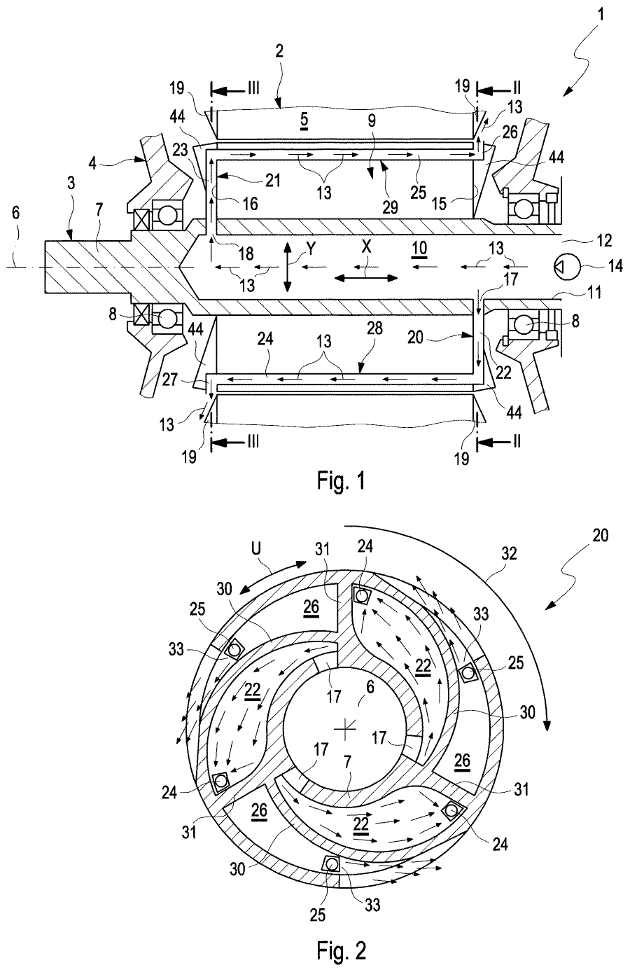

According to FIG. 1, an electric machine 1, which is preferentially a drive motor, specifically a traction motor for driving a vehicle, includes a stator 2 and a rotor 3. The stator 2 is firmly arranged in a housing 4 that is only partly noticeable here and comprises at least one stator coil 5 for generating a magnetic stator field. With respect to the stator 5, the rotor 3 is rotatably arranged about an axis of rotation 6. For this purpose, the rotor 3 comprises a rotor shaft 7, which is rotatably mounted on the housing 4 for example via bearings 8. Apart from this, the rotor 3 comprises a magnetic-field generating arrangement 9 which is configured so that it generates a magnetic rotor field at least during the operation of the electric machine 1.

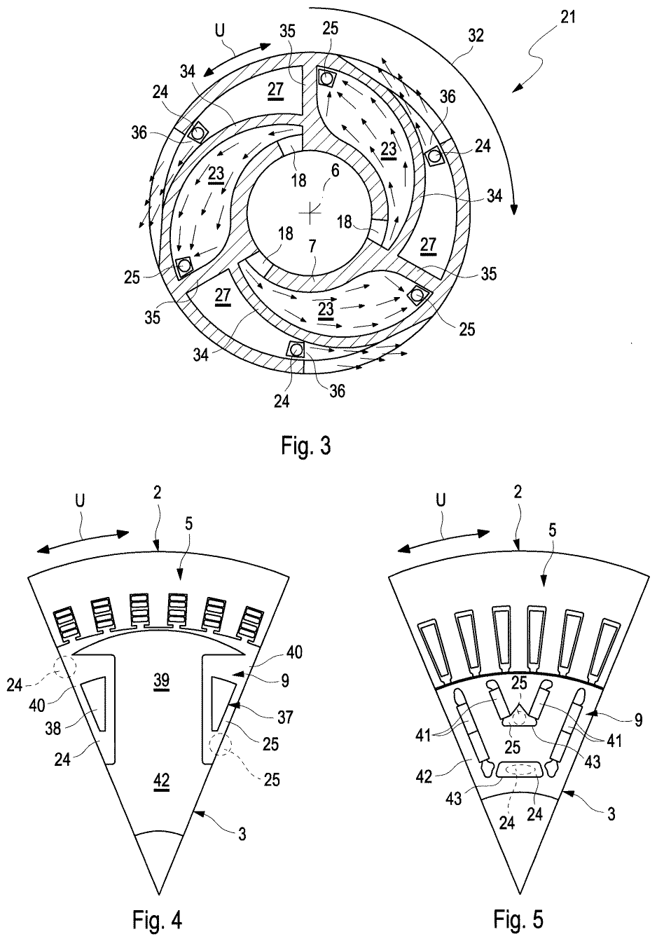

The axis of rotation 6 defines a longitudinal direction or axial direction X, which in FIG. 1 is indicated by a double arrow and which extends parallel to the axis of rotation 6. A radial direction Y extends perpendicularly to the axis of rotation 6 and is indicated by a double arrow in FIG. 1. A circumferential direction U extends round about the axis of rotation 6 and is indicated by a double arrow in FIGS. 2 and 3.

The rotor shaft 7 contains a coolant distribution channel 10 which, here, extends coaxially to the axis of rotation 6 and thus extends axially. At an axial shaft end 11, the rotor shaft 7 comprises a coolant outlet 12, which is open to the coolant distribution channel 10. By way of the coolant inlet 12, the electric machine 1 or the rotor 3 can be supplied with a liquid or gaseous coolant 13 indicated by arrows here. Here, an external delivery device 14 which is only symbolically indicated here can be employed, which can be configured as a pump or blower. The delivery device 14 is practically arranged outside the electric machine 1.

The magnetic-field generating arrangement 9 comprises a first axial arrangement end 15, which in the example of FIG. 1 faces the coolant inlet 12. Apart from this, the magnetic-field generating arrangement 9 comprises a second axial arrangement end 16, which faces away from the first arrangement end 15. The rotor shaft 7 now comprises in the region of the first arrangement end 15 multiple first radial outlet openings 17, which are each open to the coolant distribution channel 10 and of which in the section of FIG. 1 only one is noticeable. For example, three such first radial outlet openings 17 can be arranged according to FIG. 2 evenly distributed in the circumferential direction U. Coolant 13 can flow through these first outlet openings 17 along the first arrangement end 15 during the operation of the electric machine 1. Apart from this, the rotor shaft 7 comprises in the region of the second arrangement end 16 multiple second radial outlet openings 18, which are likewise open to the coolant distribution channel 10. In the section of FIG. 1 only one of these two outlet openings 18 is noticeable. For example, three such second outlet openings 18 can be arranged in FIG. 3 evenly distributed in the circumferential direction U. During the operation of the electric machine 1, coolant can flow through these second outlet openings 18 along the second arrangement end 16.

In an embodiment not shown here, the coolant 13 can radially exit from the first and second outlet openings 17, 18 and flow along the respective arrangement end 15, 16 cooling these in the process. The coolant 13 can also flow onto and cool winding ends 19 of the stator coil 5.

In the preferred embodiment shown here, the rotor 3 comprises on the rotor shaft 7, in the region of the first arrangement end 15, a first compensation ring 20 and in the region of the second arrangement end 16, a second compensation ring 21, which are each non-rotatably arranged on the rotor shaft 7. The first compensation ring 20 comprises for each first outlet opening 17 a first inflow chamber 22, which is open to the respective first outlet opening 17. Likewise, the compensation ring 21 comprises for each second outlet opening 18 a second inflow chamber 23, which is open to the respective second outlet opening 18.

The magnetic-field generating arrangement 9 comprises multiple first cooling channels 24 and multiple second cooling channels 25, which each extend axially and in the process alternate in the circumferential direction U. In the section of FIG. 1, a first cooling channel 24 is visible at the bottom and a second cooling channel 25 at the top. Each first cooling channel 24 leads on the inlet side into a first inflow chamber 22 of the first compensation ring 20 each. Each second cooling channel 25 leads on the inlet side into a second inflow chamber 23 of the second compensation ring 21 each. The first compensation ring 20 additionally comprises multiple first outflow chambers 26, which are each arranged in the circumferential direction U between two adjacent first inflow chambers 22. Apart from this, each second cooling channel 25 leads on the outlet side into such a first outflow chamber 26 each. The second compensation ring 21 comprises multiple second outflow chambers 27, which are each arranged in the circumferential direction U between two adjacent second inflow chambers 23. Apart from this, each first cooling channel 24, on the outlet side, leads into one such second outflow chamber 27. Thus, the following paths through the rotor are obtained for the coolant 13. According to a first coolant path 28, the coolant 13, during the operation of the electric machine 1, flows from the coolant inlet 12 into the coolant distribution channel 10 and from the same through the first outlet openings 17 into the first inflow chambers 22. From the first inflow chambers 22, the coolant 13 enters through the first cooling channels 24 into the second outflow chambers 27. There, the coolant 13 can then radially exit from the rotor 3 or from the second compensation ring 21 and for example impinge on the winding ends 19 of the stator coil 5 at the second arrangement end 16. According to a second coolant path 29, the coolant 13, during the operation of the electric machine 1, flows from the coolant inlet 12 into the coolant distribution channel 10 and from the same through the second outlet openings 18 into the second inflow chambers 23. From the second inflow chambers 23, the coolant 13, through the second cooling channels 25, enters the first outflow chambers 26. There, the coolant 13 can then radially exit from the rotor 3 or from the first compensation ring 20 and for example impinge on the winding ends 19 of the stator coil 5 at the first arrangement end 15.

Since the rotor 3 rotates during the operation of the electric machine 1, the coolant 13 contained therein accordingly co-rotates. Thus, the coolant 13 is subjected to centrifugal forces. Through the radial orientation of the inflow chambers 22, 23, the centrifugal forces can drive the coolant 13 in the paths 28, 29. Thus, the external delivery device 14 can be dimensioned comparatively small or be even omitted.

In the example shown here, three first cooling channels 24 and three second cooling channels 25 are provided according to the FIGS. 2 and 3, which alternate in the circumferential direction U. Accordingly, three first inflow chambers 22 and three first outflow chambers 26 are formed in the first compensation ring 20 according to FIG. 2, which alternate in the circumferential direction U. Analogously thereto, three second inflow chambers 23 and three second outflow chambers 27 are formed in the second compensation ring 21 according to FIG. 3, which alternate in the circumferential direction U. According to FIG. 2, the first inflow chambers 22 and the first outflow chamber 26 extend in the first compensation ring 20 each in the circumferential direction U, wherein the inflow chambers 22 and the outflow chamber 26 overlap in the circumferential direction U. The mutual overlapping thus takes place so that the respective first inflow chamber 22 radially adjoins the respective first outflow chamber 26 on the outside, i.e. is arranged radially further inside. It is noticeable that the respective first inflow chamber 22 is separated from the respective first outflow chamber 26 by a first separating wall 30. The respective first separating wall 30 delimits the associated first inflow chamber 22 radially inside and the associated first outflow chamber 26 outside. The respective first separating wall 30 starts at a first radial web 31 in the vicinity of the respective first outlet opening 17 and then extends curved radially to the outside and counter to a rotor direction of rotations 32 in the circumferential direction U. The rotor direction of rotation 32 is indicated in FIG. 2 by an arrow and materialises during the operation of the electric machine 1. According to FIG. 2, the respective first outflow chamber 26 comprises a first outflow opening 33, which is open radially and in the circumferential direction U counter to the direction of rotation 32.

According to FIG. 3, the second inflow chambers 23 and the second outflow chamber 27 in the second compensation ring 21 each extend in the circumferential direction U, wherein the second inflow chambers 23 and the second outflow chamber 27 overlap in the circumferential direction U. The mutual overlap takes place in such a manner that the respective second inflow chamber 23 adjoins the respective second outflow chamber 27 radially outside, i.e. is arranged radially further inside. It is noticeable that the respective second inflow chamber 23 is separated from the respective second outflow chamber 27 by a second separating wall 34. The respective second separating wall 34 delimits the associated second inflow chamber 23 radially inside and the associated second outflow chamber 27 radially outside. The respective second separating wall 34 starts at a second radial web 35 in the vicinity of the respective second outlet opening 18 and then extends curved radially to the outside and counter to the rotor direction of rotation 32 in the circumferential direction U. The rotor direction of rotation 32 is indicated in FIG. 3 by an arrow and materialises during the operation of the electric machine 1. According to FIG. 3, the respective second outflow chamber 27 has a second outflow opening 36, which is open radially and in the circumferential direction U counter to the direction of rotation 32.

In the example of FIG. 1, the first cooling channels 24 and the second cooling channels 25 are arranged in the radial direction Y relatively far outside on or in the magnetic-field generating arrangement 9. Thus, the first cooling channels 24 according to FIG. 2 can, on the outlet side, in each case lead to the region of the second outflow opening 33 of the respective second outflow chamber 26. Analogously thereto, the second cooling channels 25 according to FIG. 3 can lead to the outlet side in each case in the region of the second outflow opening 36 of the respective second outflow chamber 27.

From the FIGS. 2 and 3 it is evident, further, that the respective first outflow chamber 26 converges in the circumferential direction U towards the respective first outflow opening 33. Likewise, the respective second outflow chamber 27 converges in the circumferential direction U towards the respective second outflow opening 36. Further it is provided here that the respective first inflow chamber 22 diverges from the first radial outlet opening 17 towards the respective first cooling channel 24. Apart from this, the respective second inflow chamber 23 diverges from the respective second radial outlet opening 18 towards the respective second cooling channel 25.

Preferably, the electric machine 1 is a synchronous machine that is configured as an externally excited electric machine 1. Thus, the magnetic-field generating arrangement 9 comprises at least one rotor coil 37 indicated in FIG. 4, which during the operation of the electric machine 1 serves for generating the magnetic rotor field. In FIG. 4, a winding 38 of the rotor coil 37 is additionally shown, which is wound onto a pole shoe 39. The respective pole shoe 39 is a part of the magnetic-field generating arrangement 9. The magnetic-field generating arrangement 9 comprises multiple such pole shoes 39, which follow one another in the circumferential direction U and each carry a winding 38. Practically it can now be provided that the first and second cooling channels 24, 25 extend between adjacent pole shoes 39 in the circumferential direction U. It can be provided in particular that axial grooves 40, which are located in the circumferential direction U between adjacent pole shoes 39, form or receive these cooling channels 24, 25. In FIG. 4, two variants each for the first cooling channel 24 and the second cooling channel 25 are indicated, wherein with interrupted line a channel worked into a body 42 of the magnetic-field generating arrangement 9 is indicated.

The windings 38 have axial winding ends which are noticeable in FIG. 1 and designated by 44. These winding ends 44 are each located in the region of the arrangement ends 15, 16. Practically it can now be provided that the first and second inflow chambers 22, 23 and/or the first and second outflow chambers 26, 27 are axially open towards these winding ends 44, so that the coolant 13 can directly impinge on and cool these winding ends 44.

However, the electric machine 1 can also be configured as a permanently excited electric machine 1. According to FIG. 5, the magnetic-field generating arrangement 9 then comprises multiple permanent magnets 41, which serve for generating the magnetic rotor field. For this purpose, the permanent magnets 41 are arranged distributed in the circumferential direction U in a body 42 of the magnetic-field generating arrangement 9. To increase the output, the magnetic-field generating arrangement 9 can comprise multiple axially extending flux separating gaps 43, which are formed in the body 42. These flux separating gaps 43 are located in the circumferential direction between two adjacent permanent magnets 41 where they form a gap in the body 42, which interrupts the magnetic flux through the body 42 at this point. The flux separating gaps 43 can form or receive the first and second cooling channels 24, 25. In FIG. 5, two variants for the first and the second cooling channel 24, 25 each are reproduced, wherein with interrupted line a channel worked into the body 42 of the magnetic-field generating arrangement 9 is indicated.

1.-20. (canceled)

21. An electrical rotary transformer for inductive energy transmission, comprising:
a rotary transformer stator including a primary coil;
a rotary transformer rotor rotatable relative to the rotary transformer stator about an axis of rotation, the rotary transformer rotor including a secondary coil at least one of inductively coupled and inductively couplable to the primary coil;
a capacitive coupler for capacitive electrical signal transmission between the rotary transformer stator and the rotary transformer rotor, the capacitive coupler partly formed on the rotary transformer stator and partly formed on the rotary transformer rotor;
the capacitive coupler including a first plate capacitor and a second plate capacitor that each include a first plate element and a second plate element;
the two first plate elements arranged on the stator and the two second plate elements arranged on the rotary transformer rotor, the first plate element and the second plate element of each of the first plate capacitor and the second plate capacitor disposed opposite one another for capacitive coupling;
the rotary transformer rotor including a secondary coil printed circuit board that is rotatable about the axis of rotation with respect to the rotary transformer stator and on which the secondary coil is arranged, the secondary coil formed by at least one conductor track provided on the secondary coil printed circuit board;
the two second plate elements each formed by at least one conductor track composed of a metal and formed on the secondary coil printed circuit board;
the two first plate elements and the two second plate elements each having an annular geometry;
the two first plate elements and the two second plate elements arranged coaxially to one another;
a transformer core of a magnetic core material arranged on the rotary transformer stator;
the transformer core surrounding a coil receiving space in which the primary coil and the secondary coil printed circuit board are arranged with the secondary coil;
the transformer core formed annularly and coaxially to the axis of rotation;
the transformer core having an inner circumference and, on the inner circumference, a recess, the recess opening radially to an inside, the secondary coil printed circuit board arranged in the recess with a radially outer printed circuit board section on which the secondary coil is arranged;
the recess including an axial depression in which the primary coil is received;
wherein the capacitive coupler is arranged outside of at least one of the transformer core and the coil receiving space; and
wherein the primary coil and the secondary coil are arranged at a larger radial distance from the axis of rotation than the capacitive coupler.

22. The rotary transformer according to claim 21, wherein the two plate capacitors are arranged at a distance from one another along a radial direction extending perpendicularly away from the axis of rotation.

23. The rotary transformer according to claim 21, wherein the two first plate elements are arranged on an additional printed circuit board, which is arranged axially at a distance from the secondary coil printed circuit board.

24. The rotary transformer according to claim 23, wherein the two first plate elements are each formed by a conductor track composed of a metal and arranged on the additional printed circuit board.

25. The rotary transformer according to claim 21, wherein:
the two first plate elements are arranged on two different additional printed circuit boards; and
the secondary coil printed circuit board is arranged axially between the two additional printed circuit boards.

26. The rotary transformer according to claim 25, wherein the two second plate elements are arranged on axially opposite sides of the secondary coil printed circuit board such that one of the two second plate elements axially faces the first plate element arranged on a first additional printed circuit board of the two additional printed circuit boards, and the other one of the two second plate elements axially faces the first plate element arranged on a second additional printed circuit board of the two additional printed circuit boards.

27. The rotary transformer according to claim 21, wherein the first plate capacitor and the second plate capacitor are arranged next to one another along an axial direction extending along the axis of rotation.

28. The rotary transformer according to claim 21, wherein the two first plate elements and the two second plate elements are each formed rotationally symmetrically to the axis of rotation.

29. An externally excited electrical synchronous machine, comprising:
a synchronous machine stator, which is electrically suppliable with current, for providing a magnetic stator field;
a synchronous machine rotor, which is electrically suppliable with current and is rotatable with respect to the synchronous machine stator, for providing a magnetic rotor field, the synchronous machine rotor including a synchronous machine rotor shaft; and
an electrical rotary transformer according to claim 21, the rotary transformer connected in a rotationally fixed manner to the synchronous machine rotor shaft.

30. The externally excited electrical synchronous machine according to claim 29, wherein the two plate capacitors are arranged at a distance from one another along a radial direction extending perpendicularly away from the axis of rotation.

31. The externally excited electrical synchronous machine according to claim 29, wherein the two first plate elements are arranged on an additional printed circuit board, which is arranged axially at a distance from the secondary coil printed circuit board.

32. The externally excited electrical synchronous machine according to claim 31, wherein the two first plate elements are each formed by a conductor track composed of a metal and arranged on the additional printed circuit board.

33. The externally excited electrical synchronous machine according to claim 29, wherein:
the two first plate elements are arranged on two different additional printed circuit boards; and
the secondary coil printed circuit board is arranged axially between the two additional printed circuit boards.

34. The externally excited electrical synchronous machine according to claim 33, wherein the two second plate elements are arranged on axially opposite sides of the secondary coil printed circuit board such that one of the two second plate elements axially faces the first plate element arranged on a first additional printed circuit board of the two additional printed circuit boards, and the other one of the two second plate elements axially faces the first plate element arranged on a second additional printed circuit board of the two additional printed circuit boards.

35. The externally excited electrical synchronous machine according to claim 29, wherein the first plate capacitor and the second plate capacitor are arranged next to one another along an axial direction extending along the axis of rotation.

36. The externally excited electrical synchronous machine according to claim 29, wherein the two first plate elements and the two second plate elements are each formed rotationally symmetrically to the axis of rotation.

37. An electrical rotary transformer for inductive energy transmission, comprising:
a rotary transformer stator including a primary coil;
a rotary transformer rotor rotatable relative to the rotary transformer stator about an axis of rotation, the rotary transformer rotor including a secondary coil at least one of inductively coupled and inductively couplable to the primary coil;
a capacitive coupler for capacitive electrical signal transmission between the rotary transformer stator and the rotary transformer rotor, the capacitive coupler partly formed on the rotary transformer stator and partly formed on the rotary transformer rotor;
the capacitive coupler including a first plate capacitor and a second plate capacitor that each include a first plate element and a second plate element;
the two first plate elements arranged on the stator and the two second plate elements arranged on the rotary transformer rotor, the first plate element and the second plate element of each of the first plate capacitor and the second plate capacitor disposed opposite one another for capacitive coupling;
the rotary transformer rotor including a secondary coil printed circuit board that is rotatable about the axis of rotation with respect to the rotary transformer stator and on which the secondary coil is arranged, the secondary coil formed by at least one conductor track provided on the secondary coil printed circuit board;
the two second plate elements each formed by at least one conductor track composed of a metal and formed on the secondary coil printed circuit board;
the two first plate elements and the two second plate elements each having an annular geometry;
the two first plate elements and the two second plate elements arranged coaxially to one another;
a transformer core of a magnetic core material arranged on the rotary transformer stator;
the transformer core surrounding a coil receiving space in which the primary coil and the secondary coil printed circuit board are arranged with the secondary coil;
the transformer core formed annularly and coaxially to the axis of rotation;
the transformer core having an inner circumference and, on the inner circumference, a recess, the recess opening radially to an inside, the secondary coil printed circuit board arranged in the recess with a radially outer printed circuit board section on which the secondary coil is arranged;
the recess including an axial depression in which the primary coil is received;
wherein the capacitive coupler is arranged outside of at least one of the transformer core and the coil receiving space;
wherein the primary coil and the secondary coil are arranged at a larger radial distance from the axis of rotation than the capacitive coupler;
wherein the two plate capacitors are arranged at a distance from one another along a radial direction extending perpendicularly away from the axis of rotation; and
wherein the two first plate elements and the two second plate elements are each formed rotationally symmetrically to the axis of rotation.

38. The rotary transformer according to claim 37, wherein:
the two first plate elements are arranged on an additional printed circuit board, which is arranged axially at a distance from the secondary coil printed circuit board; and
the two first plate elements are each formed by a conductor track composed of a metal and arranged on the additional printed circuit board.

39. The rotary transformer according to claim 37, wherein:
the two first plate elements are arranged on two different additional printed circuit boards;
the secondary coil printed circuit board is arranged axially between the two additional printed circuit boards; and
the two second plate elements are arranged on axially opposite sides of the secondary coil printed circuit board such that one of the two second plate elements axially faces the first plate element arranged on a first additional printed circuit board of the two additional printed circuit boards, and the other one of the two second plate elements axially faces the first plate element arranged on a second additional printed circuit board of the two additional printed circuit boards.

40. The rotary transformer according to claim 37, wherein the first plate capacitor and the second plate capacitor are arranged next to one another along an axial direction extending along the axis of rotation.
